(19) United States
(12) Patent Application Publication
(10) Pub. No.: US 2026/0203532 A1
(43) Pub. Date: Jul. 16, 2026

(54) Method of Specifying Properties of a Technical Entity

(71) Applicant: IP Aptly, Inc., San Diego, CA (US)

(72) Inventors: Ghobad Heidari-Bateni, San Diego, CA (US); Matthias Blume, San Diego, CA (US)

(73) Assignee: IP Aptly, San Diego, CA (US)

(21) Appl. No.: 19/397,847

(22) Filed: Nov. 21, 2025

Related U.S. Application Data
(60) Provisional application No. 63/724,178, filed on Nov. 22, 2024.

(51) Int. Cl. G06F 40/58; G06F 18/21; G06F 18/22; G06F 40/284; G06F 40/30

(52) U.S. Cl. CPC G06F 40/58; G06F 18/217; G06F 18/22; G06F 40/284; G06F 40/30

(57) ABSTRACT

The invention relates to a method comprising: receiving a user input in a first language format; segmenting the user input into a plurality of input segments; retrieving, based on the user input, at least one specification among a set of specifications, wherein the specification is in a second language format and specifies a property of a technical entity; and mapping each input segment to at least one specification segment in the at least one specification.

### CROSS REFERENCE TO RELATED APPLICATION

This application claims priority to U.S. patent application Ser. No. 63/724,178, filed Nov. 22, 2024, which is incorporated herein by reference in its entirety.

### BACKGROUND

User Interfaces (UI) are the points of interaction between a user and a system, typically a computer, application, or device. The goal of a UI is to enable users to communicate with the system effectively, making it easier to control the device, perform tasks, or retrieve information.

There are different types of user interfaces. For example, a graphical user interface (GUI) is the most common type of interface where users interact with graphical elements like windows, icons, buttons, and menus. Examples include desktop OS interfaces like Windows or macOS.

A touch-Based UI is common in mobile devices, where users interact with the system through gestures, taps, and swipes. Examples include smartphones and tablets.

Furthermore, recent speech-based UIs allow users to interact with a system using voice commands. Examples include Amazon's Alexa, Apple's Siri, and Google Assistant.

Such recent speech-based user interfaces (SBUI) like Amazon Alexa or Apple Siri are complex systems that allow users to interact with devices and services using voice commands. These systems use advanced technologies, such as Automatic Speech Recognition (ASR), Natural Language Processing (NLP), and Natural Language Generation (NLG), to interpret, process, and respond to user queries in a human-like manner.

Alexa, Siri, and similar systems can control a wide range of devices and services. For instance, they can manage smart home devices, such as turning on lights, adjusting thermostats, or locking doors. They can also play music, set reminders, send messages, make phone calls, or provide real-time information like weather updates and traffic reports. Users can ask for directions, control media playback, and even shop online through voice commands. Additionally, these systems integrate with Internet of Things (IoT) devices, enabling broader control over home security systems, smart appliances, and entertainment setups. The seamless integration of voice commands with these devices enhances convenience and efficiency, making these systems indispensable tools in modern households and workplaces.

The rise of large language models (LLMs), such as GPT-4, has revolutionized how computers process and understand human language. These models have significantly expanded the capability of computers to interpret, generate, and manipulate language in a manner that was once exclusive to humans. This leap is the result of advances in artificial intelligence (AI), specifically deep learning and transformer architectures, which enable LLMs to process increasingly complex language with high accuracy and nuanced understanding. LLMs have indeed proven to properly understand and process natural human language. However, they are computationally expensive and can thus process only limited amount of input text. Moreover, they have been trained on diverse sources, from books and articles to websites and technical documentation. Thus, they are not specialized in particular domains.

Controlling a machine using natural language presents several key challenges. Conventionally, machines are operated using structured systems such as machine code, programming scripts, or control menus, all of which follow strict, predefined syntax and terminology specific to the machine's technical specification. This technical language is precise, rigid, and often tied directly to the machine's internal operations and configurable properties, which are detailed in complex specifications. To control a machine effectively, the user needs to understand these codes, scripts, or menus, as well as how to interact with them within the framework of the machine's structure.

Natural language, by contrast, is fluid, ambiguous, and highly flexible in its syntax and vocabulary. It can vary greatly depending on the user and context, which makes it very different from the rigid, exact commands required by machines. For instance, while a machine may require specific command inputs that correspond to particular settings, a user may express the desired action in natural language in a way that seems logical but does not correspond directly to the machine's programmed commands.

One significant issue arises from the fact that modern machines, especially complex ones like medical imaging systems or telecommunications devices, are not governed by a single control script or menu. These systems often involve multiple interconnected modules, each defined by separate machine codes, scripts, or control parameters. As a result, even if a natural language query makes sense to a human user, it may inadvertently combine commands that, from the machine's perspective, relate to entirely different modules or systems.

This mismatch can lead to confusion because the user is often unaware of the underlying technical complexity and different control layers. When they issue a command in natural language, they may mix up settings or actions that seem to relate logically in their mind but are, in reality, specified in different parts of the machine's control system. This disjunction between the natural language input and the machine's technical framework presents a significant challenge in making natural language control feasible for complex systems.

Effectively translating natural language into machine-understandable commands requires not only an understanding of the machine's technical specifications but also the ability to map these disparate technical requirements to the flexible, often vague inputs provided by users. This involves creating systems that can parse, interpret, and accurately convert natural language into actionable machine commands, while also handling the complexity of dealing with multiple control specifications within the same machine.

Large Language Models (LLMs), such as GPT-4, have advanced capabilities in understanding and generating natural language. Multiple LLMs can be combined to carry out a common task such as retrieval augmented generation (RAG), but they still face significant challenges in controlling complex machines based on natural language queries, particularly when the machine is governed by technical standards like those in telecommunications. The main difficulty arises from the disconnect between the natural language input provided by a non-expert user and the rigid, highly structured nature of the technical specifications that govern how a complex system operates.

A telecommunication system, for instance, is typically configured according to a large set of technical specifications defined by a standards body (like 3GPP for mobile communication). These specifications are highly detailed and cover a broad range of configurations, functionalities, and operational parameters. Each part of the system—such as radio access, core network, service layers, and security protocols—might be defined by separate technical documents. These documents have strict syntax, terminology, and constraints, which ensure precise and reliable operation of the system.

### SUMMARY OF THE DISCLOSURE

The present disclosure relates in a first aspect to a method comprising: receiving, e.g. by a computing system on which one or several AI (e.g. machine learning or deep learning) models are running, a user input in a first language format, segmenting the user input into a plurality of input segments (optionally also referred to as a “chunk”), retrieving, based on the user input, at least one specification among a set of specifications, wherein the specification is in a second language format and specifies a property of a technical entity (and/or of an operation of a technical entity), mapping each input segment to at least one specification segment (optionally also referred to as a “passage”) in the specification, optionally by matching the input segment with the specification segment across the first and second language using the one or several AI models.

By providing such a method, the present disclosure proposes to segment the user query (i.e. user input) into functional input segments of text, retrieve one or several concerned specifications (e.g. of the standard) and map the input segments to respective specification segments (e.g. properties/configurations/settings in the specification) by translating these input segments into the language of the specification.

Accordingly, the proposed solution addresses the challenge of mapping a non-expert user's natural language query to the specific technical language needed to control a complex system, such as a telecommunication system. The computer device or the AI model is designed to break down the user's query into “input segments,” which are manageable components of the query, and retrieve relevant sections of the technical specifications for each input segment. This way, instead of dealing with the entire set of specifications and the entire query, the AI focuses on the most relevant specification segments for each input segment of the user's query.

Once these input segments are identified, the AI maps them to the corresponding specification segments in the technical documentation. For example, a query like “make the network faster for streaming” could be broken into input segments related to “network speed” and “streaming,” which may involve adjustments to bandwidth allocation or transmission settings, depending on the specifications. The AI then translates the user's vague or ambiguous language into the precise technical terms needed for configuration.

The system's understanding of the logical relationships between these input segments helps resolve ambiguity in the user's query. For instance, if a user queries “better streaming in high-density areas,” the AI knows this may involve adjusting both network capacity and data prioritization. By retrieving only the relevant parts of the technical specifications and linking them to the user's intent, the AI reduces complexity, enhances accuracy, and allows for more flexible query interpretation. This approach not only simplifies the interaction between the user and the machine but also ensures that the query is accurately translated into the machine's specific configurations.

The terms “AI model”, “AI models”, “model”, or just “AI” may be used interchangeably in the present disclosure.

The term “segmenting the input text into input segments” may refer rather to a “semantic segmentation” than a “syntactic segmentation”. In other words, “segmenting” may not be limited to cutting the input text into several pieces, but may also imply converting the text to obtain the input segments. An input segment may be generated based on several pieces of information in the user input which may be distributed across the user input (i.e. not necessarily in a single string of text taken from the user input). For example, to generate an nth input segment, a first, fifth, sixth and eighth piece of information from the user input may be used.

An information piece may e.g. be a single word (e.g. a key word, like “speed”), a term comprising several words (like “internet speed”), or a clause or subordinate clause (like “increase internet speed). Different techniques are known to identify such an information piece, e.g. conventional NLP techniques to identify key words, or deep learning techniques to identify terms or clauses.

Moreover, at least one information piece of the user input may also be used to generate several input segments. For example, in case an information piece is “internet”, this information piece may be used to generate several input segments, because these several input segments may be related to or influenced by said information piece.

In this context, the term “language format” refers not only to the traditional concept of human languages, such as English or German, but more broadly to any system of structured communication or expression used in a particular field. A language format can encompass human languages, but it can also refer to specialized technical languages, coding languages, or even different terminologies used within a specific domain, such as legal or scientific language. The distinction between language formats involves variations in how concepts, instructions, or information are expressed based on the context in which they are used.

For example, in a technical setting, a language format could represent the structured expressions found in computer programming, where syntax and semantics differ from natural human language. In this case, terms and structures may be highly specific to the software or system involved, and the “language” refers to the manner in which instructions are given to machines.

The method described in the present disclosure allows for a user to input their query in one language format, which may represent their natural understanding of the subject matter, and the system maps this input to a different language format used in technical specifications or other structured content. For instance, the user may describe a technical process in their own words, which do not align directly with the formal or legal terminology used in patent claims or technical documentations. The AI models employed by the system are designed to bridge this gap by segmenting the input into parts and finding corresponding sections in the technical specification, even if these are expressed in a different language format, such as technical terms or a formal patent claim language.

In another case, a user could be querying a system in one technical language format, such as a description of a process in plain text, while the system needs to retrieve relevant information from a specification that uses another format, like mathematical models, code snippets, tables, figures, charts, chemical structures, etc. The system would then map these two formats by interpreting the input and aligning it with the structure of the technical content.

Additionally, it is important to note that the differentiation between language formats may not always involve two distinct languages or technical systems. In certain cases, the user's input and the retrieved information may both be in the same language format, but the system may still perform segmentation and mapping to identify relevant segments. For example, in a scientific research application, both the input and the specification could be scientific papers, but the system might still segment the input (such as an abstract) and map it to the relevant sections in other documents that contain similar topics or concepts.

Thus, the concept of “language format” broadly encompasses any structured method of communication or representation within a particular field, whether that be human language, technical jargon, or specialized terminologies. The AI models in the system are designed to interpret and map across these varied formats to ensure that the user's input is matched with the most relevant information, even when the expressions differ in nature or structure. The actual differentiation between specific languages could be addressed in dependent claims, ensuring flexibility for applications across various fields.

A “specification” may broadly refer to a detailed and structured description of a system, product, process, or concept that outlines its key features, functionality, requirements, or characteristics. This may take various forms depending on the context in which it is used, and it serves as a blueprint or reference for understanding how something operates, how it should be constructed, or how it should perform. The term can apply across different domains, ranging from legal and technical documentation to academic papers and marketing materials, and it encompasses various kinds of structured information.

For example, in the context of a scientific publication or “paper,” the term “language format” refers to the specific style, structure, and terminology used within the document to communicate scientific findings. It encompasses not just the natural language (such as English, German, or Chinese) in which the paper is written, but also the formal conventions, technical vocabulary, and organization that are unique to the scientific discipline or field being discussed.

Scientific papers follow a standard structure that includes sections such as abstract, introduction, methods, results, discussion, and conclusion. Each section serves a particular purpose and adheres to a specific format for presenting information. For instance, the abstract summarizes the paper's objectives and key findings in a concise and formal manner, while the methods section often uses technical jargon to describe the experimental procedures in detail. This highly structured way of presenting information is a defining characteristic of the “language format” in scientific publications.

In terms of terminology, the language format of a paper is often specialized, using field-specific terms and acronyms that may not be familiar to those outside the discipline. For example, a paper in molecular biology might refer to “PCR amplification” or “CRISPR-Cas9 gene editing” without explaining what those terms mean, assuming the reader already understands them. The level of detail and precision in the language used is critical for ensuring reproducibility and clarity in scientific communication.

The style of a scientific paper is typically impersonal, objective, and evidence-based, avoiding colloquial expressions or subjective opinions. This ensures that the focus is on the data and interpretations rather than the author's personal views. Citations are also an important part of the language format, as papers must reference previous research to contextualize new findings, contributing to the ongoing scholarly conversation.

For example, a scientific paper investigating climate change might contain phrases like “statistical analysis of atmospheric CO2 concentrations over a 50-year period demonstrates a significant increase in mean global temperatures.” This sentence exemplifies the language format of a scientific publication: it is formal, technical, and precise, with a focus on data and statistical evidence.

For instance, a standard—such as those published by organizations like ISO—sets forth agreed-upon rules, guidelines, or characteristics for a product or process, and the language format here is formal and precise, designed to ensure uniformity and compliance across industries. In contrast, a patent specification includes a detailed description of an invention, often using highly formal and legal language. It outlines how the invention works, its components, and claims that define the scope of legal protection. Here, the language format is technical and legalistic, requiring precise terms and rigid structure. On the other hand, an academic publication may use a different language format focused on scientific reasoning, with terms specific to the field of research, data interpretations, and methodologies. These documents are structured around hypotheses, experiments, results, and conclusions, using a more narrative form of expression compared to the rigid and formulaic patent language.

In the context of marketing materials, the specification might describe a product's features, benefits, and potential uses, but the language is generally less technical and more persuasive, often designed to appeal to the customer rather than to explain the exact engineering details. In contrast, product technical documentation would offer in-depth information about the product's components, installation procedures, maintenance guidelines, and troubleshooting steps, typically using highly specialized language aimed at engineers or technicians.

Each of these examples uses a different language format, and the variation in expression, terminology, and structure presents challenges for AI models tasked with mapping user input to these specifications. A user's input might come in the form of general questions or unstructured language, such as “How does this invention work?” or “What are the key benefits of this product?” However, the AI system needs to translate this input into the relevant segments within the specification, which may be expressed in a completely different way, using technical or formal language that is less intuitive.

For example, mapping a user's input, “What materials can I use with this device?” to a patent application might require the AI to understand how material composition is referenced in legal language, where the term “material” may be embedded in a more complex technical description. Alternatively, in an academic publication, the answer might be found in the methodology section, where the specific materials used in experiments are listed in technical terms. Similarly, in product documentation, the materials might be referenced in a straightforward chart or list.

The AI model desirably bridges the gap between the casual or general language used by the user and the formalized, domain-specific language found in these specifications. It needs to interpret different terms and expressions in various language formats and link them to the corresponding specification passages, which may involve navigating complex terminology and formal structures. Additionally, when the language formats are particularly distinct, such as between a user-friendly marketing description and a highly technical standard, the challenge increases. The AI must be capable of understanding the essence of the query and finding the most relevant match in the specification, even when the terms and phrasing differ significantly.

Segmenting the user input into a plurality of input segments may further comprise:
determining a functional relationship between the input segments,
assigning determined functional relationships to the respective input segments, wherein
each input segment is mapped to the at least one specification segment based on the determined functional relationship.

In the context of segmenting user input into multiple segments, the term “functional relationship” may refer to the logical or meaningful connection between different parts of the user input. This relationship defines how one segment of the input relates to another in terms of purpose or function. Identifying and assigning these functional relationships allows the AI model to better understand the context of the input, enabling it to map these segments more effectively to the relevant portions of a specification.

For instance, consider a user input like, “Calculate the power output if the voltage is 220V and the current is 5 A.” The segments “Calculate the power output,” “voltage is 220V,” and “current is 5 A” are distinct, but their functional relationships connect them. The first part, “Calculate the power output,” sets the task or goal, while the second and third parts, providing the voltage and current values, act as parameters required to perform the calculation. The functional relationship here is that the voltage and current are inputs that serve the purpose of the calculation. When mapping this to a specification, such as an electrical formula or system requirements, the AI uses this relationship to ensure it identifies the correct formula (e.g., power=voltage×current) in the specification.

In another example, consider a legal context where the user asks, “What are the limitations of this license if I distribute modified software?” The segments could be “limitations of this license” and “distribute modified software.” The functional relationship is that the distribution of modified software triggers specific limitations in the license. The AI must recognize that the second part of the query is a condition or scenario, and the first part refers to the legal constraints associated with that condition. The functional relationship enables the AI to match these conditions with the appropriate clauses in the license agreement.

Functional relationships can also be more abstract, such as in scientific research. If a user input consists of “Evaluate the efficacy of treatment X based on trials conducted in 2020,” the relationships here involve both time (“trials conducted in 2020”) and the treatment (“efficacy of treatment X”). The functional relationship is one of cause and effect, where the trials provide evidence that affects the evaluation of the treatment's efficacy. The AI, recognizing these relationships, will map the input to relevant sections of a study or data set, linking the time-based context to the experimental results.

In all cases, the functional relationship serves to clarify how different segments of input are connected, helping the AI understand what role each segment plays in relation to the others. This allows the system to navigate complex user queries and map them accurately to corresponding information in a specification, even when dealing with varied or complex language formats.

Mapping each input segment further may comprise:
determining a functional relationship between the mapped specification segments according to the functional relationships assigned to the respective input segments.

Mapping each input segment further may comprise:
retrieving a plurality of candidate specification segments for each converted input segment,
selecting a specification segment among the candidate specification segments based on a matching score and a relationship score of the selected specification segments.

The matching score may represent a semantic similarity between the selected specification segment and the converted input segment.

The relationship score may be determined based on the determined functional relationship between the mapped specification segments and the determined functional relationships assigned to the respective input segments.

For example, the relationship score may be determined based on functional relationships between the selected specification segment and other specification segments selected for other input segments originating from the same user input. Said functional relationship may be compared to the functional relationships between the respective each input segment and other input segments originating from the same user input.

The other specification segments may be already selected, i.e. mapped specification segments, or may also be candidate specification segments.

Accordingly, in case the other specification segments are not yet selected but still candidate specification segments (with one or several candidate specification segments for every input segment), the overall selection (i.e. mapping) problem may be considered as a global optimization problem. For example, a predefined metric may be used to select for each input segment a respective candidate specification segment, such that the overall similarity between the functional relationships between the input segments and the functional relationships between the selected specification segments can be maximized (i.e. optimized).

According to these optional aspects of the present disclosure, the computer system or the one or several AI models processes a user's query (i.e. the user input) by breaking it down into input segments that represent specific functions or queries. A key aspect of the method may be determining the functional relationships between these input segments. By identifying how different parts of the query logically connect, the AI can assign these relationships to the input segments themselves, ensuring that each input segment may be treated not just as an isolated element but as part of a broader, coherent request. This may be crucial when a user's query involves multiple related tasks, such as adjusting multiple settings on a machine where each setting influences others

Once the relationships between the input segments are established, each input segment may be mapped to relevant specification segments in the technical specifications or documentation. The functional relationships guide this mapping process, ensuring that the chosen specification segments correspond not only to the content of the input segment but also reflect the overall intent of the query. For instance, if two input segments are functionally linked, such as “optimize for speed” and “reduce power consumption,” the mapping process will account for how these two tasks interact in the technical context, retrieving specification segments that balance both objectives.

The method also involves retrieving multiple candidate specification segments for each input segment. The system doesn't settle on the first match but evaluates various possibilities to find the most appropriate specification segment. This evaluation may be based on a matching score, which reflects how well a candidate specification segment fits the input segment's content. However, what makes this approach particularly powerful may be that it doesn't rely solely on the individual match but also considers the functional relationships between specification segments corresponding to other input segments. In other words, the system selects a specification segment not only for its direct relevance to the input segment but also for its compatibility with the other selected specification segments, ensuring that the overall configuration makes sense.

This layered approach offers several advantages. First, it ensures that the complexity and interdependency of different machine functions are fully considered when processing a user query. By recognizing the relationships between the input segments, the system avoids oversimplifying or isolating queries that should be treated as interconnected. Second, by retrieving and evaluating multiple candidate specification segments for each input segment, the system ensures a more precise and tailored response, selecting specification segments that not only match the query but also align with other settings or functions involved. Finally, the method enhances the accuracy of machine control, allowing the user to issue natural language queries while the system interprets them within the precise, structured requirements of the technical specifications, thus reducing errors and improving the overall performance of the machine.

At least one of:
segmenting the user input,
retrieving a specification, and
mapping each input segment,
   is performed using the one or several AI models.

The property may be a characteristic of the technical entity itself, e.g. specify the design or configuration of the technical entity, or may be a characteristic of the manufacturing process of the technical entity, or may be a characteristic of the operation (or an operation mode) of the technical entity. The properties may be settings of the entity which influence the way the entity may be operating.

The properties comprise mandatory properties and optional properties.

Accordingly, the term “property” may refer to a definable characteristic or attribute associated with a technical entity. Properties may describe various aspects of the entity, including its design, configuration, manufacturing process, or operation. These attributes may be intrinsic to the entity or related to how it is made or used, and they may significantly influence its performance, usability, or behavior.

For instance, design or configuration properties may refer to characteristics such as the shape, size, or internal structure of the entity. For example:

A sensor's design property may include its sensitivity, which could depend on the type of materials used or the geometric arrangement of its sensing elements.

In the case of a processor, the configuration property may include the number of cores, clock speed, or cache size, which may determine its computational efficiency.

Manufacturing process properties may refer to attributes related to how the entity is produced. For example:

For a composite material, a property of the manufacturing process may include the curing temperature or the layering sequence of the fibers.

For a drug, a property may include the synthesis pathway, such as the choice of solvents or reaction conditions, which may affect its purity or yield.

Operation properties may describe the behavior of the entity when it is in use, including its settings or modes of operation. For example:

For a medical device, an operational property may include the energy intensity of a laser used in a therapeutic procedure.

For a communication system, an operational property may include the frequency band used during transmission, which could influence its range and data rate.

These properties may further be divided into mandatory properties and optional properties:

Mandatory properties may be those that are essential for the technical entity to function as intended. For example:

A mandatory property of a battery may include its capacity in milliampere-hours (mAh), which determines how much charge it can store.

A mandatory property of a robotic arm may include its degree of freedom, which is critical for determining its range of motion.

Optional properties may be those that enhance or customize the functionality of the technical entity but are not strictly necessary. For example:

An optional property of a camera may include the ability to shoot in 4K resolution, which may enhance image quality but is not essential for basic operation.

An optional property of a chemical reactor may include automated control of pressure and temperature, which could improve efficiency but may not be required for basic functioning.

Moreover, properties may also function as settings that influence the way the entity operates. For instance:

A washing machine may have a property setting for “spin speed,” which may be adjusted based on the type of fabric being cleaned.

A drone may have a property setting for “altitude limit,” which may be modified depending on the environmental conditions or legal restrictions in the operating area.

By categorizing properties in this way, the framework allows for a systematic understanding of both essential and customizable aspects of the technical entity, enabling a more accurate mapping.

When the specification is a telecommunication standard, mandatory and facultative properties may refer to features or parameters defined within the standard that govern the operation of communication devices or systems.

A mandatory property in a telecommunication standard may include the frequency range allocated for a specific technology. For instance, in the context of 5G (Fifth Generation) networks, the standard may mandate operation within specific frequency bands, such as 3.3 GHz to 3.8 GHz for sub-6 GHz communication. Devices operating under the standard must comply with this frequency range to ensure compatibility and avoid interference.

This property is essential for ensuring interoperability between devices and network infrastructure and for compliance with regulatory requirements.

A facultative property in a telecommunication standard may include the support for beamforming technology. Beamforming is an advanced feature that focuses the signal toward specific devices to improve efficiency and performance. While the standard may define how beamforming should be implemented if used, devices are not required to support it to comply with the standard.

Beamforming is an optional enhancement that improves performance but is not critical for basic communication. Devices without beamforming capabilities can still operate within the network as long as they meet the mandatory requirements.

By distinguishing between mandatory and facultative properties, the mapping may become more accurate, as the method (i.e. the first and/or second AI module may privilege an accurate or correct mapping with regard to the mandatory properties compared to facultative properties.

The second AI model may be configured to distinguish between mandatory and facultative properties.

The second AI model may be configured to derive requested properties from the input segments. The requested properties may e.g. specify the technical target entity. Consequently, any requested properties which are determined as mandatory may be privileged by the second AI module, i.e. their accurate mapping may be privileged over an accurate mapping of a mere facultative property.

The technical entity may be at least one of a technical device, apparatus and system.

Furthermore, the technical entity may be any kind of technical device or system, such as a sensor, a processor, a medical device or a communications system. It may further include any methods or materials, e.g. developed in a chemistry or life science field. Hence, the technical entity may be any entity which may be developed or produced using engineering. The specifications may relate to respective fields, i.e. to fields relating to the technical entity.

Accordingly, the term “technical entity” may refer to any device, system, material, or process that may be developed, designed, or manufactured through engineering or scientific methods. These entities may encompass a wide range of domains and applications, making the definition intentionally broad to cover various fields of technology and innovation.

For instance, a technical entity may include:

Devices and Systems: Examples may include sensors (such as temperature sensors or motion detectors), processors (such as microprocessors or GPUs), medical devices (such as MRI machines or insulin pumps), or communications systems (such as cellular networks or satellite systems). These entities may involve complex hardware components and embedded software.

Materials: This may refer to engineered materials such as polymers, alloys, or composites developed for specific applications, or biocompatible materials used in medical implants. For example, graphene-based materials may be considered technical entities for applications in flexible electronics or batteries.

Processes and Methods: This may include methods developed in scientific disciplines, such as chemical synthesis techniques, drug discovery processes, or life sciences protocols like gene editing (e.g., CRISPR). For example, a method for producing high-purity silicon for semiconductors could be a technical entity.

Software Systems: These may be complex algorithms, frameworks, or machine learning models used for automation, prediction, or control in various fields. For instance, a software entity could be a neural network model designed to process medical imaging data for diagnostic purposes.

Integrated Systems: Some technical entities may combine multiple components, such as an autonomous vehicle that includes sensors, processors, materials, and software for navigation and safety systems.

The specifications related to these technical entities may detail aspects such as functionality, design, operational parameters, materials, or procedural steps. For example:

For a sensor, the specification may include sensitivity, accuracy, and environmental operating conditions.

For a material, the specification may describe its composition, mechanical properties, and intended application.

For a process, the specification may outline the steps, required equipment, and conditions necessary to achieve the desired outcome.

Since the technical entities may belong to a variety of fields, the specifications may also vary in structure and language, reflecting the conventions and requirements of the respective domains. For example:

In communications systems, specifications may include modulation techniques, bandwidth requirements, and latency limits.

In chemistry, they may describe reaction pathways, catalysts, and yields.

In medical devices, specifications may address biocompatibility, sterilization methods, and safety protocols.

This broad definition of technical entities ensures that the concept can encompass the wide array of innovations encountered in modern engineering, technology, and science.

The user input may be text or speech in human language, the first language format may be at least one of natural language, human-like language, spoken language, and written language, the second language format may be a (text) format of at least one of: a machine code, programming script, a control menu of a technical entity, and a technical specification of standard, such as mobile tele communication standard.

The term “first language format” may refer to a wide variety of specialized types of communication or representation beyond just spoken or written human languages. These formats may include distinct modes of information that require specific processing approaches to be understood and mapped correctly by the AI model(s).

For example, the user input according to the first language format may comprise e.g. technical language, legal language, software language, and figures and tables.

Likewise, the specification according to the second language format may comprise the same language formats like the first language format, and additionally e.g. the language formats of scientific publications and of marketing documents, and image data.

For instance, technical language is one type of first language format. It could involve instructions in an engineering manual, where the information is presented in precise terms, such as voltage levels, circuit diagrams, or hardware specifications. A user might input a query like, “What is the maximum power rating for this motor?” This query is written in natural language, but it needs to be mapped to a specification that could be full of technical terms and numbers like “Rated Power: 300 W”. The AI model needs to process both formats and translate them into a common embedding that captures the underlying meaning.

Similarly, legal language is another example of a first language format. Legal language tends to be highly formal, with strict definitions and long, complex sentence structures. For instance, a query might ask, “What are the licensing restrictions for this software?” The corresponding legal document could contain dense clauses, like “This license is granted under the terms and conditions specified herein and is non-transferable.” The AI needs to bridge the gap between the plain language of the user's question and the complex structure of legal contracts, recognizing similarities in meaning even if the wording differs. Another example of legal language may be patent language, e.g. a patent claim.

In the case of software (SW) language, the AI might be working with programming languages like Python, Java, or C++. Here, the language format consists of code, algorithms, or syntax structures. A user input might be something like, “What does this function do?” while the software specification might include code such as def calculate_sum(a, b): return a+b. The AI must map the natural language description to a specific block of code, which requires understanding both human language and software logic.

Image data is another non-traditional form of language format. It could include diagrams, charts, or illustrations that represent information visually rather than textually. For instance, a user might ask, “What is the flow of electricity in this circuit?” while the specification might include an electrical circuit diagram. The AI would need to interpret the image data, recognize the components and their relationships, and then map the query to the appropriate visual representation.

Tables represent yet another form of language format. A user might input a question like, “What are the sales figures for Q1?” while the specification might be a table in a report that lists sales numbers across multiple quarters and regions. The AI needs to extract and understand the relevant data from the table, recognizing its structure and the values that correspond to the user's query.

In all these cases, the AI is tasked with converting very different kinds of information—whether it's a legal contract, a software program, a technical diagram, or a table—into a common representation that allows for meaningful comparisons. The challenge lies in interpreting and embedding information from such varied sources so that it can effectively match input queries to the relevant parts of the specification, despite the vast differences in their original forms.

The set of specifications may be stored in a structured database which may comprise keys linking text specification segments of the specifications.

Storing technical specifications of a standard in a relational database using references as keys involves organizing the information in a way that reflects the structure of the specification and allows for efficient retrieval of related specification segments. In this context, each reference in the specification can serve as a key, allowing the database to establish relationships between different sections, subsections, and configurations within the specification.

In particular, these references (keys) in the database may be used to better retrieve functional relationships between specification segments, as they are given by the input segments of the user input.

The method may further comprise specifying a technical target entity based on the at least one specification segment, said specification segment providing at least one of a property of the technical entity and a property of the operation of the technical entity.

Accordingly, the mapped specification segment(s) may each provide or specify or describe one or more technical properties. These technical properties may be used to specify a technical target entity.

In other words, based on the initial user input the technical target entity may be specified. Hence, the method of the present disclosure may allow to a user to provide merely a simplified specification of the technical target entity. This task of providing the user input does not require the user know the precise terminology used in relevant technical specifications or the existence of such specifications at all. Instead, the user can formulate freely, how the technical target entity should be characterized.

The method may further comprise outputting, optionally as an output, at least one of: for each input segment, the at least one specification segment or at least two candidate specification segments, and statistical data determined based on at least one of the retrieved at least one or more specifications, for at least one or all input segments, the at least one specification segment or at least two candidate specification segments.

For example, the output may be provided to a user of the computing system via a user interface, e.g. a graphical user interface. The user interface may be for example a graphical user interface, e.g. displayed on a display screen connected to the computing system or any computer device associated with (e.g. operatively connected to) the computing system.

For example, the specification segments may be highlighted in their specifications, such that the user can directly see the context of these specification segments.

An output may also have any other forms, such as e.g. relevance data to found specification segments, optionally with or without showing at least one of the specification segments and the retrieved specifications. For example, the method may generate statistics for a set of user inputs. These statistics may e.g. merely provide a summary about the relevance of found specifications or specification segments in these, e.g. one or more relevance scores for each user input.

The statistical data may be used to get better global insights into the existing specifications in view of the user input (i.e. the query). For example, the statistical data may be in the form of a landscape of the retrieved specifications in view of the overall available specifications and/or a landscape of the mapped specification segments in the specifications in view of said overall specifications. For example, the statistical data may in this way provide insights into statistical correlations between the retrieved specifications or specification segments, e.g. in the form of technical similarities (e.g. by sharing a common technical concept or a common technical property).

The method may further comprise receiving a feedback (e.g. user feedback) based on the output, optionally including: the selection of the at least one retrieved specification, the refusal of the at least one retrieved specification, marking a retrieved specification as a candidate specification, switching from one retrieved specification to another, the selection of the at least one specification segment, the refusal of the at least one specification segment, marking a retrieved specification segment as a candidate specification segment, switching from one retrieved specification segment to another, a selection of one of the candidate specification segments, the refusal of all candidate specification segments, a selection of a technical property based on the statistical data.

The feedback may be provided by a user. For example, based on the provided output, a user may select at least one specification segment, e.g. using a user interface. However, the feedback may also be at least partially generated by a computer algorithm, e.g. by an AI model.

The feedback may be used for at least one of: reinforcement learning of the one or more AI models, and selecting properties of the technical entity and/or of the operation of a technical entity.

For example, in case a user refuses the output, i.e. the at least one specification segment or all candidate specification segments, this feedback may be used for reinforcement learning, i.e. to further optimize the used AI model(s).

In a further example, in case a user selects the output, i.e. the at least one specification segment or one or several candidate specification segments or statistical data (e.g. a common technical concept or a common technical property of retrieved specifications), this feedback may be used for selecting properties of the technical entity and/or of the operation of a technical entity.

The method may further comprise providing a user interface, which is designed for at least one of: receiving the user input, providing the output to a user, optionally in visual form or as speech, receiving a user feedback to an output.

The method may further comprise specifying a technical target entity based on at least one of the selected properties of the technical entity and/or of the operation of a technical entity.

Accordingly, selected properties may be used to specify a technical target entity. In other words, based on the initial user input, an output may be generated and provided to the user in an automated manner by the computing system. Based on said output and the user feedback the technical target entity may be specified.

In other words, based on the initial user input the technical target entity may be specified. Hence, the method of the present disclosure may allow a user to provide merely a simplified specification of the technical target entity. This task of providing the user input does not require the user to know the precise terminology used in relevant technical specifications or the existence of such specifications at all. Instead, the user can formulate freely how the technical target entity should be characterized and control/adjust/correct any proposals (i.e. the first output) of the computing system by providing the feedback.

The method may further comprise:
outputting a specification of the technical target entity, and/or
initiating production (e.g. using a robotic manufacturing system, a 3D printer or other) of the technical target entity or a prototype of the technical target entity.

Accordingly, the specification of the technical target entity may be used to build the target entity or prepare simulations on it.

For example, a prototype may be manufactured for further verification and possible adjustment of the specification of the technical target entity.

The one or several AI models may comprise a first AI module (e.g. also referred to as a retriever module) for retrieving the at least one specification, optionally including: a first language model trained on data in the first language format, a second language model trained on data in the second language format, and a third model which combines the outputs of the first and second language models.

The first language model may be configured to output a first embedding vector based on a fed user input. The second language model may be configured to output a second embedding vector based on a fed specification or specification element (as described in detail below). Accordingly, a specification or a specification element may be represented by a second embedding vector. The third model may be configured to align the vector spaces of the first and second embedding vectors.

The first AI module may be configured to retrieve the at least one specification by comparing the first embedding vector with the second embedding vectors, e.g. by approximate nearest neighbors or LSH, as explained below.

The second embedding vectors may be pre-computed and stored in a vector database, such asPinecone or Qdrant. In this way, the retrieval may be relatively fast, as merely the first embedding vector need to be calculated by the first language model and needs to be compared with second embedding vectors of the vector database. This also allows the use of relatively large language models, at least for the second language model, as the second embedding vectors may be pre-computed and may thus be available when the method and system is used by a user.

Accordingly, the first AI module may be configured to retrieve the at least one specification by comparing the first embedding vector, which may represent the user input in a common vector space, with the second embedding vectors. These second embedding vectors may have been pre-computed and stored in a vector database, each corresponding to different segments of a specification or related specifications. This process allows the AI module to determine the most relevant specification or specification segments in response to the user input.

For example, the comparison between the first embedding vector and the second embedding vectors may be performed using techniques such as approximate nearest neighbors (ANN) search, which is designed to efficiently find vectors in the database that are closest to the query vector (the first embedding vector) in the embedding space. This search may employ methods such as Locality-Sensitive Hashing (LSH), which optionally enables faster retrieval by hashing similar vectors into the same buckets, reducing the need for exhaustive pairwise comparisons.

For example, the first embedding vector may represent a query, such as “What are the temperature tolerances for this material?” The second embedding vectors, corresponding to text segments in various technical documents, may include information on materials, tolerances, and specifications. The AI module may use the LSH technique to hash these second embedding vectors and group similar ones together. When the user's query is encoded as the first embedding vector, the system may rapidly identify which group of hashed embeddings is most relevant, reducing computational overhead and speeding up retrieval.

The retrieved specification or specification segments may then be ranked or filtered based on additional criteria, such as semantic similarity scores or domain-specific relevance metrics, to ensure the most appropriate response is identified. This approach may allow for scalability, as the vector database can store a large number of pre-computed embeddings while maintaining fast retrieval times.

The first and second language models may be similar but trained on different data, as explained in more detail below. The first and second language models of the first AI module may be relatively large compared to the first and second language models of the second AI module which are described below, e.g. their parameter size may be 20 to 100 times larger (or even more) and/or their input size (i.e. the maximum number of tokens of the text input which can be handled by the model or the “context window” of the model) may be 10 to 50 times higher (or more).

For example, the first and second language models of the first AI module may comprise multi-billion parameters. Examples include Llama, Claude, and GPT-4. It is noted that possible types of usable language models and their sizes may change with future developments, wherein the present disclosure also covers use of any future language models, e.g. larger models. The maximum input size of the first and second language models of the first AI module may be up to several thousand tokens, e.g. app. 8K tokens or more. Optionally, the second language model of the first AI module may be larger than its first language model. This configuration may be chosen, because the user input may be relatively small compared to the specifications and may thus require not a large model.

The first AI module may be client-specific, e.g. trained using shared data and fine-tuned using client-provided data.

The algorithms/architectures for training first AI module may include an image-to-text or text-to-image learning module. In other words, the trained first AI module may be able to receive as the user input an image and retrieve the at least one specification (i.e. text) based on said image. The trained first AI module may also be able to receive as the user input a text and retrieve the at least one specification (i.e. an image in the specification or an image constituting the specification of the present disclosure) based on said text.

The first AI module may further be configured to segment each of the specifications into specification elements, e.g. by means of a pre-processing module of the first AI module or any other module, before being fed into the second language model. Accordingly, the first AI module may further be configured to retrieve the most relevant specification element(s) in the retrieved at least one specification and may hand over the most relevant specification element(s) to the mapping module (which is described below). In one example, the size of the specification elements may correspond to the input size of the first AI module, e.g. comprise up to several thousand tokens. The specification elements may be larger than the specification segments, as described below. A specification segment may be relatively small, e.g. consist of a single sentence or a part of a sentence or a small set of tokens (e.g. 1 to 20 words), meanwhile the specification elements may each have several thousand tokens. However, the specification elements may also be the specification segments.

The specifications may be grouped/classified by product in a database. The specifications may also be grouped client-specific.

The at least one retrieved specification may consist of multiple documents associated with the same product as specified based on the user input.

Alternatively, the retriever module may also be based on a fast retriever algorithm, such as e.g. BM25, without using AI models (i.e. machine learning/deep learning models).

A language model may be e.g. a LLM, i.e. a large language model.

Accordingly, the first and second models may be e.g. LLMs. The third model may merge the outputs of the first and second model and may output the output of the entirety of the one or several AI models.

The first AI module may be designed to receive as an input: the user input, optionally as input for the first language model, and at least one specification, optionally as input for the second language model, and to output at least one of: a ranking score and a relevance score of the at least one specification, optionally as output of the third model.

For example, based on the at least one of the ranking score and the relevance score, the at least one specification may be retrieved. For instance, the relevance score may be a number, e.g. between 0 and 1, which indicates how relevant the at least one specification is to the user input. The ranking score may indicate how relevant the specification is to the user input compared to other specifications, e.g. a natural number 1 to N, N being the number of specifications compared to the user input by the retriever module. For example, the specification having the highest ranking score or M specifications having the highest ranking scores (M being smaller than N) may be retrieved in this way by the retriever module.

Accordingly, the one or several AI models may further comprise a retriever module, which may be trained to retrieve, based on the user input, at least one specification among a set of specifications. For example, the retriever module may comprise the first, second and third models, which are trained on the retrieving task.

In general, an AI module may be understood as a software module which may comprise one or several AI models and optionally other software algorithms.

The one or several AI models may further comprise a first reranker model trained to rerank the retrieved specifications. The first reranker model may e.g. review and modify the ranking of the most relevant N specifications retrieved by the retriever module.

The one or several AI models may further comprise a segmentation model trained to segment the user input into a plurality of input segments.

The one or several AI models may further comprise a second AI module (e.g. also referred to as a mapping module) for mapping the input segment, optionally including: a first language model trained on data in the first language format, a second language model trained on data in the second language format, and a third model which combines the outputs of the first and second language models.

The second AI module may be designed to receive as an input:
an input segment, optionally as input for the first language model, and the at least one retrieved specification or the retrieved specification element(s) (i.e. as retrieved by the first AI module), or at least one specification segment, optionally as input for the second language model,

The second AI module may be designed to output a matching score of the at least one specification segment, optionally as output of the third model.

The first language model may be configured to output a first embedding vector based on a fed input segment. The second language model may be configured to output a second embedding vector based on a fed specification. Accordingly, a specification segment may be represented by a second embedding vector. The third model may be configured to align the vector spaces of the first and second embedding vectors.

The second AI module may be configured to map the input segment to at least one specification segment by comparing the first embedding vector with the second embedding vectors, e.g. by approximate nearest neighbors/LSH.

As explained above, the models of second AI module may be smaller than those of the first AI module. For example, the first and second language models of the second AI module may comprise hundred of millions of parameters. Examples include RoBERTa base, RoBERTa large or DistilRoBERTa. It is noted that possible types of usable language models and their sizes may change with future developments, wherein the present disclosure also covers use of any future language models, e.g. larger models. The maximum input size of the first and second language models of the second AI module may be up to several hundred tokens, e.g. 512 tokens or more. Such relatively small models may be chosen, because second AI module may process the input data in real-time (i.e. embed the input segments and specification segments in real-time into embedding vectors without using pre-computed embedding vectors). Due to the relatively small models, this process may be anyway relatively fast, e.g. taking only a few seconds or less.

The second AI module may further be configured to segment the retrieved specification or retrieved specification element(s) into specification segments, e.g. by means of a pre-processing module of the second AI module or any other module, before being fed into the second language model.

The second AI module may further be configured to (re-)rank the retrieved specifications, e.g. based on how well the input segments match specification segments.

The second AI module may be client-specific. For example, the second AI module may be trained using shared data and fine-tuned using client feedback.

For example, the method may further comprise collecting user feedback (as explained in more detail below) that may be used to refine the ranking and the mapping of each input segment to at least one specification segment.

The feedback may be trinary, as explained below. For example, the feedback may take one of three possible values or states. The three states in trinary feedback may represent different categories or levels of evaluation, depending on the context.

The feedback may be used to show a different specification and/to associate an additional or a different segment. The feedback may be used to train/tune the first and/or second AI module, The feedback may be used to describe the association between the selected specification segment(s) and input segment.

The algorithms/architectures for training second AI module may include an image-to-text or text-to-image learning module. In other words, the trained second AI module may be configured to receive as input segment an image and map it to the at least one specification segment (i.e. text). The trained first AI module may also be configured to receive an input segment in text form and map it to at least one specification segment (i.e. an image in the specification or an image constituting the specification segment of the present disclosure).

The method may further comprise displaying the mapping of each input segment to at least one specification segment in a single specification to the user (as also described in more detail below.

For example, based on the matching score the input segment may be mapped to the specification segment. For instance, the matching score may be a number, e.g. between 0 and 1, which indicates how relevant the at least one specification segment is to the input segment or how relevant the specification segment is to the input segment compared to other specification segments. For example, the specification segment having the highest matching score or several specification segments having the highest ranking scores may be mapped in this way by the mapping module.

Accordingly, the one or several AI models may further comprise a mapping module trained to map each input segment to at least one specification segment in the at least one specification. For example, the mapping module may comprise the first, second and third models, which are trained on the mapping task.

The first AI module may correspond to the second AI module. For example, the first AI module and the second AI module may be identical. It is also possible that the first AI module and the second AI module may be trained on different data.

The one or several AI models may further comprise a second reranker model trained to rerank the specification segments. The second reranker model may e.g. review and modify the ranking of the most relevant M specification segments identified to be relevant for the input segment by the mapping module.

The second AI module may be an agentic system where a supervisor agent tasks multiple matching agents with processing the multiple input segments and an aggregation agent combines the results returned by the multiple matching agents. For example, the aggregation agent may simply sum scores provided by the matching agents. Alternatively, the aggregation agent may first determine the relationships between specification segments provided by the matching agents and filter out specification segments that do not have the relationships implied by the user input prior to summing specification segment scores provided by the matching agents. For example, if the user input asks about a steering wheel of an automobile and a matching agent returns a specification segment mentioning four wheels with a score of 0.4 as well as a specification segment mentioning a wheel turned by hand with a score of 0.3, the aggregation agent could eliminate the former and only include the score of 0.3 in the sum.

The results of the mapping module of one, several or all input segments of a user input may be used to rerank a respective specification retrieved by the retriever module. For example, based on the (e.g. unsatisfying) results of the mapping module, the retrieved specifications may be reranked such that the input segments are mapped to another specification. The process may also be at least partially based on user feedback, i.e. such that a user determines whether the results of the mapping module are satisfying or not. The user feedback may be provided via a user interface of the computing system or a computer device associated with the computing system.

Moreover, user feedback may also be used by the computing system to rerank the specification segments. For example, a user interface may propose a new specification segment to a if the user marks the previous specification segment as non-applicable.

Generally, user feedback may be collected by the computing system and be used as training data for reinforcement learning of the one or more models.

Optionally, the one or several AI models may comprise a third AI module which is configured to generate an explanation for at least one input segment and its mapped specification segment. For example, the third AI module may receive as an input the input segment and its mapped specification segment and may output a comment regarding the similarity or potential differences of both segments. The third AI module may optionally additionally receive several specification segments (e.g. all being mapped to the same input segment) and compare them re. their similarity to the input segment. The specifications segments may also comprise at least one specification segment which has been annotated with a user feedback, e.g. being refused by the user. Based on such a “negative example” of a mapped specification element, the third AI module may be configured to output an argument that another one of the mapped specification segments is more relevant.

The third AI module may e.g. comprise or consist of a generative language model, such as e.g. Llama, Claude or GPT-4. The third AI module may be configured by prompt engineering to output the above-mentioned outputs (e.g. coments) based on the respective inputs.

The one or several AI models may further comprise a pre-processing model which pre-processes an initial user input into the user input in the first language format. For example, the initial user input may be speech or a text in a natural language, e.g. a short note or some keywords. The user input in the first language format may have a specific format, e.g. patent language or in the format of patent claims.

The method may further comprise at least one of:
training the first language model of at least one of the first and the second AI modules based on a first dataset in the first language format,
training the second language model of at least one of the first and the second AI modules based on a second dataset in the second language format, and
training the third model of at least one of the first and the second AI modules based on a third dataset which maps first samples in the first language format to second samples in the second language format.

Accordingly, the first and second models of at least one of the first and the second AI modules, which may be e.g. LLMs, can be trained to learn their specific language formats.

The third model of at least one of the first and the second AI modules may be trained to learn mapping the outputs of first model to matching outputs of the second model. In particular, the third model may have learned through the third data set to identify, for a first sample, i.e. for the output of the first model, one or more matching second samples in the output of the second model.

The first, second and third datasets may also be combined to a single combined dataset based on which the entirety of the one or several AI models may be trained.

For example, the single combined dataset may comprise for each training sample of a set of training samples:
a first input sample in the first language format (e.g. corresponding to a user input or a input segment), a second input sample in the second language format (e.g. corresponding to a specification or a specification segment of a specification), and a training label in the form of a binary class (e.g. relevant/not relevant) or other indicator (e.g. 0.01 to 0.99) which indicates the relevance of the second input sample for the first input sample. By such, the one or more AI models may be trained on e.g. the binary classification task and thus learn to distinguish bet relevant and not relevant second samples (e.g. corresponding to a speciation of a specification segment of a specification) for a given first sample.

The first dataset may for example comprise a dataset in patent language and/or in the form of a set of patent claims. In this case, it is. desirable that the one or several AI models may further comprise a pre-processing model which pre-processes an initial user input into the user input in the first language format, as mentioned above. Desirably, the pre-processing model may be trained to convert the initial user input (e.g. naturally spoken language) into the user input in the first (i.e. patent) language format. Since patent language, e.g. in claims corresponds to or may be at least close to naturally spoken language, the conversion may be properly learnt. Advantageously the combined dataset comprising such a first dataset may contain a large number of training samples, as a large number of patents mapped to e.g. relevant technical specifications of e.g. telecommunication standards or other product specifications exists due to public datasets from patent offices or from litigation cases. A respective patent-based combined dataset may be used as a training set, e.g. a large set of patent claims which are mapped to relevant specification segments in specifications in a second language format, e.g. of product specifications or of standards). The step of mapping the at least one input segment may be learnt using the large patent dataset.

The method may then comprise pre-processing a natural human language query into a patent claim structure.

A preliminary model may be used to convert the input text to a patent claim structure. The language of the input text in the patent claim structure may thus be the “first language format” of the present disclosure.

A machine learning model may be or may comprise a deep learning model, e.g. a neural network. A LLM may be e.g. a transformer based model.

The terms “model” and “AI model” may be used interchangeably in the present disclosure.

The specifications may also comprise images which are converted by the computing system, e.g. using the one or more AI models, to a text in the second language format.

In general, the method of the present disclosure may be performed by a computing system. Thus, the method may be a computer-implemented method. In case the method steps comprise any actions (for example physical actions) which go beyond a mere data processing operation (for example recording a voice), the computer-implemented method may further comprise instructions which, when executed by the computing device, cause the computing system to carry out these actions.

The computing system may comprise or may be associated with a user interface (e.g. provided by a computer device connected to the computing system.

The user interface may be provided e.g. by a personal computer, a smartphone, tablet or any other computer device having a user interface, e.g. via a respective app running on the smartphone. The user interface may be a graphical user interface running display on a e.g. a display screen.

For example, the user input may be provided to the computing system via the user interface, and/or the output may be provided to a user via the user interface.

The computing system may at least partially use cloud resources, e.g. cloud servers.

A second aspect of the present disclosure relates to a computing system (i.e. a data processing system) comprising a processor configured to carry out the method according to the first aspect of the present disclosure. For example, the computing system may further comprise at least one memory storing computer-executable instructions, the computer-executable instructions when executed by the processor cause the computing device and/or its processor to carry out the method according to the present disclosure.

The processor (or processing unit) may be a component of electronic devices that may be responsible for carrying out computational tasks. There may be different types of processing units, each designed for specific purposes. A processing unit may be or may comprise a Central Processing Unit (CPU), Graphics Processing Unit (GPU), Digital Signal Processor (DSP), Field-Programmable Gate Array (FPGA), and/or Application-Specific Integrated Circuit (ASIC).

A third aspect of the present disclosure relates to a machine control system comprising the computing system according to the second aspect of the present disclosure, as described above, and/or configured to carry out the method according to the present disclosure. In particular, the machine control system may be configured to specify properties of a technical entity and/or of an operation of a technical entity (i.e. control the entity, i.e. the machine).

A fourth aspect of the present disclosure relates to a computer program product comprising instructions which, when the program may be executed by a computing system, cause the computing system to carry out the method according to the present disclosure.

A fifth aspect of the present disclosure relates to a computer-readable medium, e.g., a non-transitory computer-readable medium, comprising instructions which, when executed by a computing system, cause the computing system to carry out the method according to the first aspect of the present disclosure.

It is intended that combinations of the above-described elements and those within the specification may be made, except where otherwise contradictory.

It is to be understood that both the foregoing general description and the following detailed description are exemplary and explanatory only, are provided for illustration purposes and are not restrictive for the scope as defined by the accompanied claims.

The accompanying drawings, which are incorporated in and constitute a part of this specification, illustrate examples of the disclosure and together with the description, and serve to support and illustrate the principles thereof.

### BRIEF DESCRIPTION OF THE DRAWINGS

FIG. 1 shows a schematic exemplary representation of the method of the present disclosure.

FIG. 2 schematically shows an example of the method of FIG. 1.

FIG. 3 shows a schematic exemplary representation of a computing system which is at least partially carrying out the method of the present disclosure.

FIG. 4 shows a schematic example of a graphical user interface according to the method of the present disclosure.

### DESCRIPTION OF THE DRAWINGS

In the following text, a detailed description of examples will be given with reference to the drawings. Various modifications to the examples may be made. In particular, one or more elements of one example may be combined and used in other examples to form new examples.

The rise of large language models (LLMs), such as GPT-4, has revolutionized how computers process and understand human language. These models have significantly expanded the capability of computers to interpret, generate, and manipulate language in a manner that was once exclusive to humans. This leap is the result of advances in artificial intelligence, specifically deep learning and transformer architectures, which enable LLMs to process increasingly complex language with high accuracy and nuanced understanding.

At the core of this evolution is the ability of LLMs to model vast amounts of text data. GPT-4, for instance, has been trained on diverse sources, from books and articles to websites and technical documentation. Through this extensive training, these models develop a deep understanding of linguistic structures, including syntax, semantics, context, and even implicit meanings that arise from the interplay of words. They capture the relationships between words, phrases, and sentences at multiple levels, allowing them to generate coherent responses, summarize lengthy texts, and even infer intent from ambiguous or indirect language.

One of the critical innovations in LLMs is their ability to handle context over long specification segments of text. Unlike earlier models, which struggled to maintain coherence over extended conversations or documents, models like GPT-4 can remember and refer back to information provided earlier in the interaction. This capability allows them to engage in complex dialogues, handle multi-step reasoning, and respond in a contextually appropriate way even after many turns in a conversation. This contextual understanding extends to technical jargon, creative writing, and even idiomatic expressions, making LLMs adaptable to a wide range of domains and tasks.

Moreover, LLMs can now be fine-tuned for specific applications. While general-purpose models like GPT-4 are trained broadly, they can be adjusted with domain-specific data to excel in particular fields such as law, medicine, or finance. This fine-tuning process enhances the model's capacity to deal with highly specialized language, where precision and accuracy are paramount. The result is that these models are not just responding to input based on general knowledge but can engage with subject matter expertise, delivering insights or performing tasks like drafting legal documents or diagnosing medical conditions with a level of sophistication previously unattainable by AI systems.

In addition to understanding human language, LLMs are also transforming how computers generate it. They are capable of producing text that is almost indistinguishable from that written by humans. This includes composing articles, answering detailed questions, and even creating poetry or fiction. As a result, LLMs have become instrumental in automating content creation, enhancing customer service interactions, and supporting creative industries. The complexity of the language these models can produce mirrors their ability to comprehend it, showcasing their dual role as both interpreters and creators of language.

The real-time interaction capabilities of LLMs are another remarkable aspect. With improvements in computational power and model optimization, systems like GPT-4 can respond instantly to user queries, holding real-time conversations that feel natural and responsive. These interactions are not limited to text-based interfaces; LLMs are increasingly integrated with speech-based systems like virtual assistants. They power more advanced versions of voice assistants like Siri or Alexa, improving their ability to handle complex queries, offer contextual answers, and manage diverse user needs with greater precision.

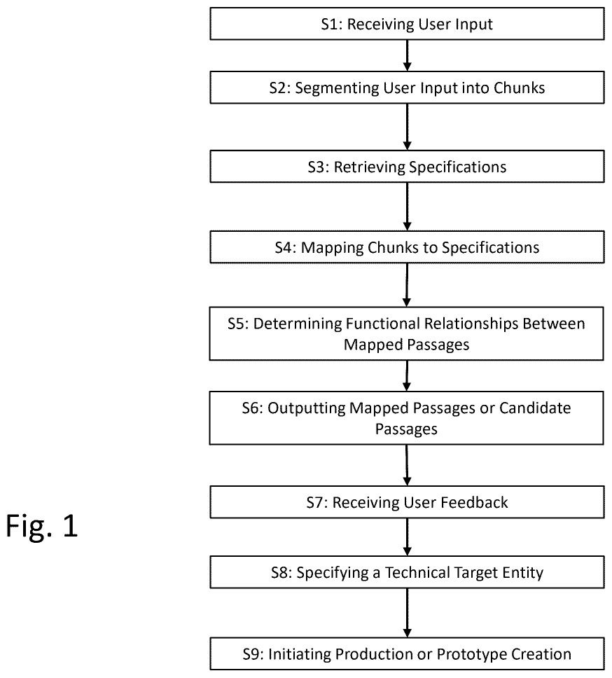

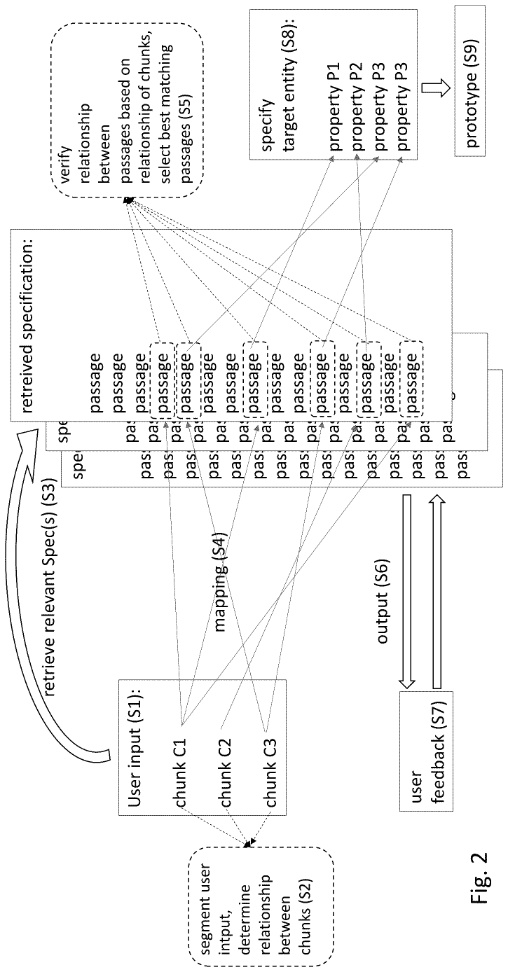

FIG. 1 shows a schematic representation of the method of the present disclosure. FIG. 2 shows schematically shows an example of the method of FIG. 1. In particular, FIG. 2 schematically shows a user input which is segmented into input segments, wherein the input segments are mapped to relevant specification segments in a retrieved specification of a technical entity. FIG. 2 further schematically shows how these specification segments are used for user interaction and to define a technical target entity.

The present disclosure, as shown schematically in FIGS. 1 and 2, outlines a method performed by a computing system, involving the translation of user input in a first language format into a second language format, corresponding to a technical specification.

The method begins in step S1 with a computing system, which runs one or several AI models (e.g. one or more LLMs), receiving a user input. This user input is provided in a first language format, which could be a natural human language such as English, either as text or speech. For example, a user might input a written or spoken user query into a user interface connected to or part of the computing system. Exemplary implementations of user interfaces are described in context of FIG. 2.

In one example, the method and user interface of the present disclosure rely on advanced technologies to allow users to interact with devices and services through voice commands. These systems follow a multi-step process to understand and respond to user input. It all starts with the detection of a “wake word,” such as “let's work”. The device continuously listens for this word, and once it is recognized, it activates the system to begin recording the user's speech. The recorded audio is then sent to the cloud for further processing.

The first major step in processing the input is Automatic Speech Recognition (ASR), which converts spoken language into text. ASR breaks down the audio into phonemes (the basic sound units of language) and matches them to the corresponding words in the system's language model. Once the speech is transcribed into text (e.g. the initial user input), the next phase, Natural Language Processing (NLP), takes over. NLP analyzes the structure and meaning of the transcribed text to extract the user's intent. It looks at the sentence structure, semantics, and the context of the command to determine what the user wants to do. Based on such initial user input, the user input may be converted into the first language.

Once the input is received, the computing system segments in step S2 the input into a plurality of input segments. Each input segment corresponds to a meaningful portion of the input that may need to be processed separately. The segmentation process may also involve determining a functional relationship between the input segments. This relationship is critical for correctly mapping each input segment to a relevant specification segment in a specification.

Based on at least one of the original input, the segmented input or the single input segments, the system retrieves in step S3 one or more relevant technical specifications from a database or repository of documents, e.g. using a retriever module. These specifications are written in a second language format, which may include machine code, programming script, or formal technical standards. The retrieval is based on the user input and its functional relationship.

For example, if the input is related to a mobile phone setting, the system may retrieve specifications from a mobile telecommunication standard, detailing how silent mode is implemented on a technical level.

Each input segment of the segmented input is then mapped in step S4 to a specification segment within the retrieved specification, e.g. using a mapping module. This involves converting the input segment from the first language format into the second language format (e.g., mapping a natural language command to a specific code or protocol that activates the command in a technical entity).

In some cases, multiple candidate specification segments may exist within the specification for each input segment. The system evaluates these candidates using a matching score, which measures the semantic similarity between the input segment and the specification segment, and a relationship score, which evaluates how the specification segments relate to one another. This ensures the selected specification segment best matches the original user input's meaning and intent.

Once the input segments are mapped to their respective specification segments in the specification, the system determines in step S5 a functional relationship between the mapped specification segments. This relation is compared to the relationships of the respective input segments. In other words, the relationship between specification segments is verified based on relationship of input segments. Based on this, the best matching specification segments are selected among the candidate specification segments.

The method then outputs in step S6 either the mapped specification segments or a selection of candidate specification segments for each input segment, e.g. via a user interface or an API to an external computer system.

The user interface presents the segmented input segments and mapped specification segments, enhancing transparency and giving users control over the final output. Unlike conventional UIs, which may obscure intermediate processing steps, this method's UI ensures users understand how their input is being interpreted and acted upon.

In addition to the output, the system may provide statistical data, such as the confidence level associated with each mapping. This allows for further refinement and enhances user interaction.

After presenting the output, the system allows in step S7 the user to provide feedback. This may involve: Confirming or rejecting the selected specification segment, Choosing one specification segment from a list of candidates, Refusing all options and providing further clarification.

This feedback is valuable for the system's continuous improvement, as it enables reinforcement learning of the AI models, enhancing future performance by adjusting mappings based on real-world feedback.

Once the correct specifications are selected, the system may define in step S8 a technical target entity. In the mobile phone example, this could involve configuring the phone's operating system to enter silent mode based on the user's specifications. This step involves applying the selected properties to the actual device, system, or apparatus being controlled. A technical entity may be any kind of technical device or system, such as a sensor, a processor, a medical device or a communications system. It may further include any methods or materials, e.g. developed in a chemistry or life science field. Hence, the technical entity may be any entity which may be developed or produced using engineering. The specifications may relate to respective fields, i.e. to fields relating to the technical entity.

In some cases, the method may extend in step S9 to the production of a technical target entity or the creation of a prototype. For instance, if the user input pertains to the design of a new device, the system can generate a specification that leads to the development of a prototype.

In one example of the described method, the user might input “Optimize the power settings of a server.” The system segments the input into input segments, retrieves the appropriate server specification from a technical database, and maps each input segment to a command that adjusts server power settings.

In another example of a software development environment, a developer could input a query like “Update the API to version 2.” The system retrieves the relevant API documentation and maps the input to the technical specification segments detailing the version 2 update process.

This method leverages multiple AI models to complete different aspects of the process. Specifically, the system may include:
A first language model of at least one of the retriever module and the mapping module trained on data in the first language format (e.g., English),
A second language model of at least one of the retriever module and the mapping module trained on data in the second language format (e.g., technical specifications, machine code),

A third AI model of at least one of the retriever module and the mapping module that integrates and processes the outputs from both language models, ensuring coherent and accurate mapping.

The combined use of AI models allows the system to handle complex and nuanced language inputs, as well as highly technical documents.

The method may leverage cloud resources, allowing for parallel processing of different AI models, significantly reducing the time taken for language conversion and specification retrieval. Cloud-based databases of specifications ensure up-to-date and comprehensive information.

By using matching and relationship scores, the method ensures high accuracy in mapping natural language inputs to technical specifications. This reduces errors and allows users to interact with technical entities more intuitively.

Accordingly, the method outlined in FIGS. 1 and 2 represents a comprehensive approach to translating user input into technical specifications using a cloud-based, AI-powered system. By combining segmentation, mapping, and functional relationship detection, it efficiently processes complex user queries and generates precise outputs that can be applied to technical entities. The system's cloud implementation enhances scalability, and its interactive user interface offers transparency and control.

In the following a concrete example of the method of the present disclosure is described in the context of specifying a telecommunication system.

A telecommunication system, for instance, is typically configured according to a large set of technical specifications defined by a standards body (like 3GPP for mobile communication). These specifications are highly detailed and cover a broad range of configurations, functionalities, and operational parameters. Each part of the system—such as radio access, core network, service layers, and security protocols—might be defined by separate technical documents. These documents have strict syntax, terminology, and constraints, which ensure precise and reliable operation of the system.

The following challenges may arise for LLMs in controlling or specifying a complex machine, such as a telecommunication system:
A non-expert user may formulate a query that is clear in natural language but ambiguous or incomplete when translated into technical commands. For instance, the user might ask, “How can I optimize the network speed for users?” This query is broad and imprecise because optimizing “network speed” could mean adjusting several different parameters across multiple parts of the telecommunication system, such as bandwidth allocation, radio access control, or data routing protocols.

Furthermore, non-expert users are usually unaware of the internal structure and terminology used in the machine's technical specifications. For example, telecommunication standards may define different parameters like “CQI (Channel Quality Indicator)”, “MCS (Modulation and Coding Scheme)”, or “RLC (Radio Link Control)”, none of which would be known or understood by a non-expert. The user's natural language query might fail to mention or specify these parameters, leading to incomplete or irrelevant machine instructions.

Furthermore, a single user query often involves actions that span multiple layers of the system and, consequently, multiple technical specifications. Continuing the previous example, optimizing network speed could involve adjusting radio frequency (RF) parameters, which might be governed by one specification, and modifying how data packets are handled at the core network, which could be covered by another specification. The LLM would need to not only understand the natural language query but also map it to a series of changes that may involve several independent specifications, each with its own rules and constraints.

Furthermore, implementing a user query in a complex system like a telecommunication network must also comply with technical standards and regulations. An LLM may understand the query but fail to ensure compliance with specific industry standards or legal regulations, leading to improper or non-compliant system configurations. For instance, adjusting certain settings in the radio access network may violate spectrum allocation rules, which are strictly defined in the technical standards.

Consider a non-expert user who issues a query like: “Make the mobile network faster for streaming video in urban areas.” This query, though understandable in natural language, is highly ambiguous and broad from a technical perspective. Achieving “faster” mobile network performance for video streaming involves multiple aspects of the telecommunication system and impacts several specifications. This query could map to the following different technical areas:

Radio Access Layer (RAN) Configuration: Adjusting parameters such as CQI reporting, MIMO (Multiple Input Multiple Output) settings, or beamforming techniques might be required to optimize signal quality in urban environments, which is covered in the specifications for radio access technology.

Core Network Configuration: Modifying traffic routing, ensuring low-latency paths, and managing data prioritization are governed by the core network specifications. A change in how video data packets are prioritized or handled requires referencing specifications that govern QoS (Quality of Service) or bearer management in the core network.

Data Compression and Encoding Standards: Optimizing video streaming might also involve adjusting the encoding protocols for video transmission. These protocols are specified in separate documents related to multimedia transport, which have their own set of rules and configuration parameters.

In this case, even if the LLM correctly understands the user's natural language query, it would need to translate that query into several different configuration changes across multiple technical specifications, each of which may have unique syntax and constraints. Furthermore, it would need to ensure that these changes are compatible with one another and comply with regulatory requirements, something that requires a deep understanding of both the system's architecture and the applicable standards.

In summary, the complexity lies in the mismatch between the human user's ambiguous natural language and the precise, multifaceted nature of technical specifications governing the machine. LLMs can understand natural language but struggle to bridge the gap between vague user intent and the specific, technical actions required to control a complex machine.

According to the method of the present disclosure, the proposed solution addresses the challenge of mapping a non-expert user's natural language query to the precise technical language and configuration settings of a complex machine, like a telecommunication system, governed by a set of detailed technical specifications. The core idea is to design and/or train an AI model to decompose the user's query into input segments and then retrieve relevant specifications. This way, the AI can effectively translate the natural language into specific machine actions that align with the system's technical requirements. Accordingly, the method of the present disclosure provides the following key Aspects:

Decomposing the User Query into Input segments: When a user provides an ambiguous or broad query, the AI breaks down the input into smaller, more manageable input segments that represent distinct functional components. For example, in the query “Make the network faster for streaming in urban areas,” the input segments could be “network speed,” “streaming,” and “urban areas.” Each of these input segments corresponds to a specific set of operations or configurations that might be scattered across different parts of the technical specification.

Retrieving Relevant Specifications: Once the query is broken into input segments, the AI model then retrieves the most relevant technical specifications from a larger set. The idea is that not all technical documents are needed to answer the query—only a subset that is directly related to the functional areas in question. For instance, improving “network speed” might concern the radio access network, while “streaming” performance might require specifications on multimedia transmission protocols. By narrowing down the scope, the AI reduces the complexity and amount of information that needs processing.

Mapping to Technical Specification segments: Each input segment is then translated or mapped to the corresponding specification segments in the retrieved specifications. This step involves converting the user's natural language, which may be vague or imprecise, into the specific language used by the technical specification. For example, “make the network faster” might correspond to increasing “CQI reporting frequency” or adjusting “MIMO antenna settings,” depending on the context. The AI's role is to correctly interpret the user's intent and link it to the appropriate settings and configurations defined in the technical documentation.

Resolving Ambiguity through Functional Understanding: Ambiguity in user queries can be resolved by understanding the functional or logical relationships between the input segments. For example, the user might ask for “better quality video streaming in high-density areas.” While “better quality” is a vague term, the AI can infer that this might involve adjustments to both the radio access and core network settings. By analyzing the relationships between “video streaming” and “high-density areas,” the AI determines that changes in bandwidth allocation or data prioritization might be necessary.

The method of the present disclosure thus provides several advantages.

By cutting the query into smaller functional parts and retrieving only the relevant portions of the technical specifications, the AI reduces the complexity of the task. Instead of trying to map the entire user query to the entire standard, the AI focuses on a smaller subset, streamlining the processing.

By breaking down the query into logical input segments, the AI achieves a more granular understanding of the user's intent, improving its ability to map ambiguous or unclear language to specific technical terms and configurations.

Because the AI retrieves only the relevant technical specifications and specification segments, it reduces the chance of errors due to irrelevant information or misinterpretation of the user's query.

The AI model(s) can accommodate non-expert queries, even if they are incomplete or vague, by decomposing them into distinct functions and mapping those functions to the appropriate technical specifications. This allows for more natural and flexible interactions between the user and the machine.

Overall, the proposed AI-driven method creates a bridge between the user's natural language input and the highly structured, technical world of machine configuration. It allows the system to interpret vague or ambiguous queries by reducing them to their functional components and matching them with relevant sections of the machine's technical documentation.

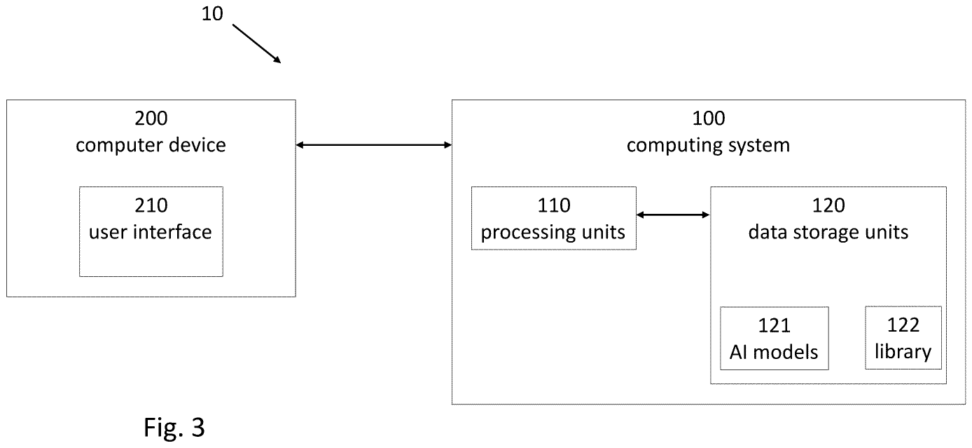

FIG. 3 shows a schematic representation of a computing system which is at least partially carrying out the method of the present disclosure.

In brief, the computing system 10 may comprise processing resources 100, e.g. cloud-based processing resources, such as one or several processing units (e.g. CPUs and/or GPUs) and data storage resources, e.g. for storing the one or several AI models and the library of specifications, e.g. organized by a relational database. The computing system may be for example a server system. The computing system 10 may further comprise or may be connectable to an optional computer device 200 providing a graphical user interface 210 for receiving the user input and outputting the outputs according to the present disclosure. The processing resources, i.e. the computing system 100 may thus receive the user input via the optional computer device 200. The optional computer device 200 may thus be referred to as a front end device of the computing system 10 and the processing resources 100 as a back-end system of the computing system 10.

Accordingly, FIG. 3 provides a schematic representation of a computing system 100 that partially or fully carries out the method described in this disclosure. The system is connected to a user device 200 equipped with a graphical user interface (GUI) 210, enabling interactions such as receiving user inputs and presenting outputs. The primary components of the computing system, as shown in FIG. 3, include processing units 100, e.g. cloud-based processing resources (e.g., CPUs, GPUs), data storage units, AI models 121, and a library of technical specifications 122, which can be organized in a relational database.

The computing system is designed to efficiently execute the complex steps involved in the method described earlier, which includes language processing, specification retrieval, and mapping. Central to the system's implementation are the cloud-based processing resources, which are scalable and distributed across several processing units, such as central processing units (CPUs) and graphics processing units (GPUs).

The system utilizes cloud resources in a non-obvious manner tailored to the specific computational requirements of AI-driven specification mapping. For instance, a series of AI models are distributed across the cloud, optimizing resource utilization. The first language model, which processes the user's natural language input, can be executed on one cloud node, while the second model, which processes technical specifications in the second language format, runs on another node. This parallel processing reduces latency and improves throughput.

Additionally, cloud-based GPUs can handle the high computational demand of machine learning tasks, such as determining matching and relationship scores between input segments of user input and candidate specification segments in specifications. By offloading computationally intensive tasks to cloud resources, the system can scale according to real-time demand, reducing costs and ensuring efficient use of resources.

The system may comprise various data storage resources used to store the AI models, user inputs, and the extensive library of specifications. These storage resources could include distributed storage solutions hosted in the cloud, which can offer several advantages:

The specifications are stored in a library 122, e.g. in the form of structured databases, such as relational databases, that allow for efficient retrieval of specific specification segments relevant to the user's input. These databases can be optimized for the specific retrieval task by implementing indexing mechanisms that map user queries to relevant specification segments based on keys and metadata.

The cloud-based storage ensures low latency access to large datasets of specifications. The specifications may be organized according to industry standards, technical documents, or API documentation, depending on the technical domain of the user input.

The described method offers several advantages over conventional cloud computing practices, especially in terms of resource efficiency:

Cloud resources can be dynamically allocated depending on the complexity of the user input. For example, a simple query might only require a small fraction of the cloud's processing power, whereas more complex queries involving multiple specification documents may trigger the allocation of additional GPUs or CPUs to accelerate processing.

The distributed nature of cloud resources allows for parallel processing of the input at multiple stages. Language processing, input segment segmentation, specification retrieval, and mapping can be executed concurrently across different cloud nodes, significantly reducing processing time.

The cloud implementation enables the system to scale depending on user demand. If many users access the system simultaneously, cloud resources can be scaled up automatically, ensuring uninterrupted service. Conversely, resources can be scaled down during off-peak times to reduce operational costs.

Cloud-based data storage offers built-in redundancy, ensuring that critical datasets, such as the library of technical specifications, are always accessible even in case of hardware failure. Additionally, advanced security measures can be implemented at the cloud level to protect sensitive user input and technical specifications.

The computing system incorporates multiple AI models 121 to perform the various stages of language translation and specification mapping:
A first language model (i.e. of at least one of the first and the second AI modules, as described above) may be trained to process natural language input (first language format) from the user. This model is likely based on transformer architectures, which excel at understanding and segmenting human language into actionable input segments.

A second Language model (i.e. of at least one of the first and the second AI modules, as described above) processes the second language format, which corresponds to technical specifications.

A third model (i.e. of at least one of the first and the second AI modules, as described above), e.g. comprising or consisting of a cosine similarity layer, combining outputs from both the first and second language models, ensuring semantic and functional coherence between the user input and the technical specifications retrieved.

Accordingly, the matching process may involve transforming both user inputs and specification texts into embeddings through their respective first and second models. These embeddings may be compared using a cosine similarity layer to determine how closely aligned they are in meaning. The system can handle inputs in different language formats—such as non-technical natural language, technical/scientific specification, machine language, etc.—by training the models on distinct but related types of data. This allows the architecture to make accurate matches, even when the language (i.e. of the first and second language formats) differs.

For example, each of these models may be trained on separate datasets using cloud-based training pipelines. For example, the first language model may be trained on large corpora of natural language text, while the second model is trained on formal technical documents or machine code. The third model is refined using pairs of input-output samples, ensuring a high degree of accuracy when mapping user queries to technical specifications. In more detail, two separate models may be used, with the first model designed to process user inputs, such as natural language queries, and the second model trained to handle more structured and technical data, such as specifications from documents. Both models may be built on transformer-based architectures, such as Llama (in particular, the encoder part of Llama) or other large language models, known for their ability to handle vast amounts of text and capture deep contextual meaning.

According to an example, when the user input is fed into the first model, it processes the input using its layers of attention and transformation to generate an embedding, e.g. in the form of a vector. This embedding is a numerical representation of the input, capturing its semantic meaning in a high-dimensional space. Similarly, the second model processes the specification text and generates its corresponding embedding. Both embeddings exist in a shared representation space, meaning they are designed to be comparable even though they come from different models or different language formats.

To enable this comparison, a cosine similarity layer may be placed on top of both models. Cosine similarity is a mathematical measure of the angle between two vectors in a multi-dimensional space. If two embeddings are similar in meaning, their vectors will point in nearly the same direction, resulting in a cosine similarity value closer to 1. If they are very different, the value will be closer to 0 or even negative. By calculating this similarity, the system determines how well the input segment aligns with the specification segment, even if the language used in both is different.

For example, suppose the input segment is a user query such as, “What is the recommended storage temperature for this device?” The first model, trained on user-friendly language, processes this input and converts it into an embedding that captures the essence of the question. On the other hand, the second model processes a specification segment such as, “The device should be stored at a temperature between 5° C. and 30°C.” Although the words and structure differ, the underlying semantic meaning is similar—both are about storage temperature.

Through the cosine similarity layer, the embeddings generated by both models are compared. The closer the cosine similarity value is to 1, the stronger the match between the input and the specification. This similarity allows the system to effectively match the user's query to the relevant section of the specification, even though the input and specification may use different language formats—such as colloquial user queries versus highly technical language.

In terms of the model architecture, both the first and second models may consist of multiple transformer layers. These layers allow the models to pay attention to different parts of the input text and understand relationships between words, which is essential for capturing the meaning behind the text. Each model is fine-tuned for its respective task—one for user input processing, the other for handling technical specifications.

The embeddings themselves are dense vectors with hundreds or even thousands of dimensions. Each dimension represents some aspect of the meaning, context, or relation between words. This high-dimensional space enables the models to make nuanced comparisons between inputs and specifications, even when they use different terms or structures.

For instance, the training process for these models may involve supervised learning where pairs of inputs and specifications are labeled as similar or different. Over time, the models learn to adjust their internal representations so that similar inputs (like questions about storage temperature) map to similar areas in the embedding space, regardless of how the information is phrased.

The model architecture described for matching input segments with specification segments may be built using neural network techniques, particularly transformer models like LLama or other large language models (LLMs) commonly used for tasks involving natural language understanding and generation. These models are highly effective in tasks that involve mapping language inputs to corresponding outputs due to their ability to capture deep contextual information and semantic meaning.

The computing system interfaces with a user device 200 providing a graphical user interface (GUI) 210. The GUI allows for the user to input user queries and/or commands. Users may input text or speech in a natural human language through the GUI. The GUI then forwards this input to the cloud-based computing system for further processing.

The GUI further allows to output results. The GUI displays the output of the processing steps, which may include candidate technical specifications, feedback prompts, or statistical confidence levels regarding the mappings.

Unlike conventional interfaces, which may provide limited control over complex technical systems, the described GUI offers transparency and user control at every stage of the process. For example, the user is given feedback regarding the mapped specification segments, including a selection of candidate specification segments and related statistical data. This transparency increases user trust in the system and allows for more refined control over the interaction between the user and technical entities.

Accordingly, the system 10 of FIG. 3 represents a robust cloud-based computing system designed to efficiently execute the complex tasks of user input processing, specification retrieval, and mapping. The cloud infrastructure allows for scalable, low-latency processing, while the use of AI models ensures precise and accurate mappings between natural language input and technical specifications. The system's user interface provides transparency and interactivity, enhancing user control over technical operations. Through dynamic resource allocation and parallel processing, this system demonstrates significant advantages over conventional cloud computing implementations.

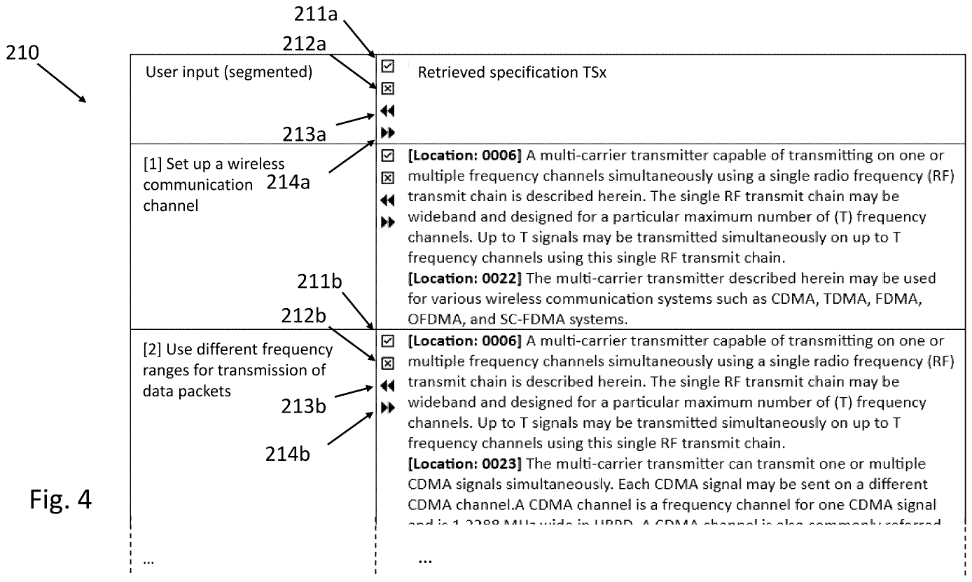

FIG. 4 shows a schematic example of a graphical user 210 according to the method of the present disclosure. The user interface may principally comprise two columns: On a left side the user input may be displayed. On the right side the retrieved specification(s) may be displayed. The user input may be shown in a segmented form, wherein each row shows one input segment. Correspondingly, the retrieved specification (in the shown example the specification “TSx”) may be shown in segmented form, wherein each row shows a specification segment, which matches with the input segment in the same row (i.e. to which the input segment of the same row has been mapped by the one or several AI models).

As shown in FIG. 4, it is also possible that more than one specification segment is mapped to an input segment and thus shown in the user interface, cf. e.g. the two specification segments (i.e. Locations 0006 and 0022) mapped to the first input segment [1].

The user interface may provide further areas or input fields (not shown) for inserting the user input (e.g. by typing or via speech recognition). In addition, it may be possible that the user changes the text of the user input directly in the fields of the input segments. In this way, it may also be possible that the user refines the retrieval and mapping process.

The segmentation may be made automatically by the computing system or may be made semi-automatically or fully manually. For example, a user may control the segmentation by inserting line breaks into the text of the user input: By inserting a line break in one input segment, said input segment may be separated into two input segments at this position. Likewise, by removing a line break, two input segments may be merged. In this way it may e.g. become possible that an automatically generated segmentation can be manually adapted by a user. Accordingly, the user interface may be designed such that the user can refine the mapping process by adjusting the input segments,

In the shown example, only the first two input segments of the user input are shown. The user input may however comprise more input segments. Likewise, for the retrieved exemplary specification “TSx” only the mapped specification segments for the two first input segments are shown.

The user interface may provide one or several feedback options 211a-214a and 211b-214b to the user. The options may e.g. be implemented as selectable (e.g. klickable) buttons in the graphical user interface.

The options may in particular include an option 211a which (e.g. when clicked by the user) triggers the selection of the at least one retrieved specification, an option 212a, which triggers the refusal of the at least one retrieved specification. Accordingly, the user has the possibility to select an entire specification as “relevant” or to refuse it entirely, if the specification is considered as irrelevant. Furthermore, the options may in particular include options 213a and 214a which allow the user to switch between retrieved specification. For example, the specification with the highest ranking score may be initially displayed by the user interface when a user input is provided to the computing system. By means of options 213a and 214a, the user may switch to specifications with lower ranking scores, starting with the second highest ranking score, then the third highest ranking score, and so on.

These options 213a and 214a may further provide feedback to the computing system by keeping the switched specifications as candidate specification, i.e. which may be considered as potentially relevant. In summary, the options 211a to 214a may be allow the user to give feedback to the computing system on a specification level.

Moreover, the options may include options 211b to 214b may be allow the user to give feedback to the computing system on a specification segment level. Hence, as shown in FIG. 4, for each input segment to which one or several specification segments are mapped, such feedback options 211b to 214b may be provided. It is also possible that for each mapped specification segment, such feedback options 211b to 214b are provided (not shown in FIG. 4) This would mean that e.g. for each of the specification segments (i.e. Locations 0006 and 0022) mapped to the first input segment [1] feedback options 211b to 214b would be provided.

For example, an option 211b (e.g. when clicked by the user) may trigger the selection of a mapped specification segment. Moreover, an option 212b may trigger the refusal of the at least one retrieved specification. Accordingly, the user has the possibility to select the specification segment as “relevant” or to refuse it, if the specification segment is considered as irrelevant.

In a further example, the user interface may be designed to allow to the user to mark a particular text passage in a specification segment and select (e.g. via the select button 211b or another button) this marked passage as relevant. In this way, the user may provide feedback to the computing system that the marked passage is considered as relevant and optionally that the rest of the specification segment is not relevant or less relevant. The same principle may be possible with regard to the refusal of a particular marked text passage within in specification segment (e.g. via the refusal button 2112 or another button).

Furthermore, options 213b and 214b may allow the user to switch between mapped specification segments. For example, the specification segment(s) with the highest match score may be initially displayed by the user interface when a user input is provided to the computing system. By means of options 213b and 214b, the user may switch to specification segments with lower matching scores, starting with the second highest match score, then the third highest match score, and so on.

The options 213b and 214b may further provide feedback to the computing system by keeping the switched specification segments as candidate specification segments, i.e. which may be considered as potentially relevant.

The feedback may be used for reinforcement learning of the one or more AI models. For example, in case a user selects or refuses a specification segment or an entire specification, this feedback may be used for reinforcement learning, i.e. to further optimize the used AI model(s).

For example, the feedback may be used to finetune the one or several AI models and thereby may allow to customize the one or several AI models, e.g. for individual customers of the computing system. In this context it is possible that the feedback received from a particular customer is used only to finetune the one or several AI models provided to this customer. In this way it can be avoided that the feedback of a first customer is enhancing the services of the one or several AI models provided to a second customer.

For instance, the feedback may be used to finetune the last layer or several last layers of the third AI module of at least one of the retriever module and the mapping module. In particular, the selection and refusal of entire specifications may be used to finetune the retriever module and the selection and refusal of specification segments may be used to finetune the mapping module.

In a further example, the feedback may be used to merely finetune the one or several last layers of the third model of the mapping module. The retriever module may be optionally not finetuned using by the feedback. Accordingly, it becomes possible to provide customized mapping modules (i.e. finetuned on particular customer feedback) which share a common retriever module.

In case a user selects a specification segment or an entire specification, this feedback may be used for selecting properties of the technical entity and/or of the operation of a technical entity. Hence, the selection of the properties may be made semi-automatically, i.e. by proposing candidate specifications and in particular candidate specification segments to the user which may give feedback to them. Alternatively, the properties may also be selected automatically by the computing system based on the retrieved specifications and in particular the mapped specification segments.

Throughout the description, including the claims, the term “comprising a” should be understood as being synonymous with “comprising at least one” unless otherwise stated. In addition, any range set forth in the description, including the claims should be understood as including its end value(s) unless otherwise stated. Specific values for described elements should be understood to be within accepted manufacturing or industry tolerances known to one of skill in the art, and any use of the terms “substantially” and/or “approximately” and/or “generally” should be understood to mean falling within such accepted tolerances.

The terms “record” and “receive” may be used synonymously throughout this disclosure unless denoted differently.

Although the present disclosure herein has been described with reference to particular examples, it is to be understood that these examples are merely illustrative of the principles and applications of the present disclosure.

It is intended that the specification and examples be considered as exemplary only, with a true scope of the disclosure being indicated by the following claims.

A reference herein to a patent document or any other matter identified as prior art, is not to be taken as an admission that the document or other matter was known or that the information it contains was part of the common general knowledge as at the priority date of any of the claims.

1. A computer-implemented method, comprising:
receiving a user input in a first language format;
segmenting the user input into a plurality of input segments;
retrieving, based on the user input, at least one specification among a set of specifications, wherein the specification is in a second language format and specifies a property of a technical entity; and
mapping each input segment to at least one specification segment in the at least one specification.

2. The method of claim 1, wherein
each input segment is mapped by matching the input segment with the specification segment across the first and second language, optionally using one or several AI models.

3. The method of claim 1, wherein
each input segment is mapped by converting the input segment and the specification segment to embeddings in a common representation and comparing the embeddings, optionally using one or several AI models.

4. The method of claim 1, wherein
the method is performed by a computing system on which one or several AI models are running.

5. The method of claim 1, wherein segmenting the user input into a plurality of input segments further comprises:
determining a functional relationship between the input segments; and
assigning determined functional relationships to the respective input segments, wherein each input segment is mapped to the respective at least one specification segment based on the determined functional relationship.

6. The method of the claim 5, wherein
mapping each input segment further comprises:
determining a functional relationship between the mapped specification segments according to the functional relationships assigned to the respective input segments.

7. The method of claim 1, wherein mapping each input segment further comprises:
retrieving a plurality of candidate specification segments for each converted input segment; and
optionally selecting a specification segment among the candidate specification segments based on a matching score and a relationship score of the selected specification segments.

8. The method of claim 7, wherein the matching score represents a semantic similarity between the selected specification segment and the converted input segment.

9. The method of claim 1, wherein the relationship score is determined based on the determined functional relationship between the mapped specification segments and the determined functional relationships assigned to the respective input segments.

10. The method of claim 1, wherein at least one of: segmenting the user input;
retrieving a specification; and mapping each input segment, is performed using one or a plurality of AI models.

11. The method of claim 1, wherein the properties are adjustable settings of the entity which influence the way the entity is operating.

12. The method of claim 1, wherein the first language format comprises the format of at least one of: a natural language, a human-like language, a technical language, a legal language, a programming language, image data and tables.

13. The method of claim 1, wherein the second language format comprises the format of at least one of: the first language format, a machine code, a control menu of a technical entity, a technical specification, a scientific publication, and a marketing language image data.

14. The method of claim 1, wherein the set of specifications are stored in a structured database which comprises keys linking text specification segments of the specifications.

15. The method of claim 1, further comprising:
specifying a technical target entity based on the at least one specification segment, said specification segment providing a property of the technical entity.

16. The method of claim 1, further comprising:
outputting, optionally as an output, at least one of:
for each input segment, the at least one specification segment or at least two candidate specification segments, and
statistical data determined based on at least one of the retrieved at least one or more specifications, for at least one or all input segments, the at least one specification segment or at least two candidate specification segments.

17. The method of claim 16, further comprising:
receiving a feedback to an output, optionally including:
the selection of the at least one retrieved specification,
the refusal of the at least one retrieved specification,
marking a retrieved specification as a candidate specification,
switching from one retrieved specification to another,
the selection of the at least one specification segment,
the refusal of the at least one specification segment,
marking a retrieved specification segment as a candidate specification segment,
switching from one retrieved specification segment to another,
a selection of one of the candidate specification segments, the refusal of all candidate specification segments, and
a selection of a technical property based on the statistical data.

18. The method of claim 17, further comprising:
using the feedback for at least one of: reinforcement learning of the one or more AI models, and selecting at least one of a property of the technical entity.

19. The method of claim 1, further comprising at least one of:
outputting a specification of the technical target entity, and
initiating production of the technical target entity or a prototype of the technical target entity.

20. A computer-readable, non-transitory, programmable product comprising code
for causing a processor to do the following:
receive a user input in a first language format;
segment the user input into a plurality of input segments;
retrieve, based on the user input, at least one specification among a set of specifications, wherein the specification is in a second language format, specifying a property of a technical entity; and
map each input segment to at least one specification segment in the at least one specification.
